(19) United States
(12) Patent Application Publication
(10) Pub. No.: US 2006/0106712 A1
(43) Pub. Date: May 18, 2006

(54) Method and Apparatus for Online Buyer Oriented Reverse Auction System

(76) Inventors: Min Guo, Long Grove, IL (US); Hui Li, Long Grove, IL (US)

Correspondence Address: MIN GUO, 5327 RFD, LONG GROVE, IL, 60047, US

(21) Appl. No.: 11/163,808

(22) Filed: Oct. 31, 2005

Related U.S. Application Data
(60) Provisional application No. 60/628,169, filed on Nov. 17, 2004.

(51) Int. Cl. G06Q 40/00

(52) U.S. Cl. 705/37

(57) ABSTRACT

Methods and apparatus are described for facilitating transactions between a plurality of buyers and a plurality of sellers via the Internet. Product information relating to a plurality of products meeting product criteria specified by a group of buyers is presented via the Internet. Buyers place requests for products at desired levels. The mechanism automatically aggregates the buying power and bundles it for sellers to bid on. The present invention provides an easy B2C/B2B mechanism for sellers as well as a mechanism for buyers to benefit from wholesale prices.

### FIELD OF THE INVENTION

The present invention relates to the use of networked systems for implementing an on-line buyer-oriented reverse auction system for the purchase and selling of goods and services between a plurality of buyers and a plurality of sellers.

### BACKGROUND OF THE INVENTION

With the increasing popularity of the Internet, computer-based systems have become an extremely popular method for buying and selling a variety of products. Most of the web sites are seller-oriented. The common ways of selling are either seller fixes prices such as Amazon.com or sells the item from auction site such from Ebay.com. In both cases, buyers are forced to purchase at the fixed price or bid with each other to get the product at higher price. Online comparison shopping services start to shift the power from seller to buyer. Buyers begin to benefit from comparison and are able to find product at lower price.

Buyer oriented web sites such as priceline.com gives buyers an opportunity to name their own price (U.S. Pat. No. 5,794,207). The business model focuses on facilitating a transaction between a buyer and at lease one of a plurality of sellers. It is time consuming for sellers to look at every small offer coming in. Buyer does not get wholesale price benefit since buyer is dealing with seller alone.

Ariba Inc has been granted a patent named “Facilitator for Aggregating Buyer Power in an On-Line Market System” (U.S. Pat. No. 6,584,451). The method is to offer sellers an interface to submit seller schedule and buyers use buyer's interface to bid. The more buyers coming in, the lower the price it will be for the buyers. This approach is still seller oriented since sellers initiate the bidding process. There is no competition between sellers.

Thus, a method and an apparatus are needed to aggregate the buyer power and reverse the bidding process.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a block diagram of an online buyer oriented reverse auction system for carrying out this present invention.

FIG. 2 is a block diagram illustrating trading cycle for product auction in this system.

FIG. 3 is a block diagram of using matching criteria to match orders from order queue and bids from bid queue.

FIG. 4 is a table diagram summarizing the activities of buyer, seller and facilitator in three different phases.

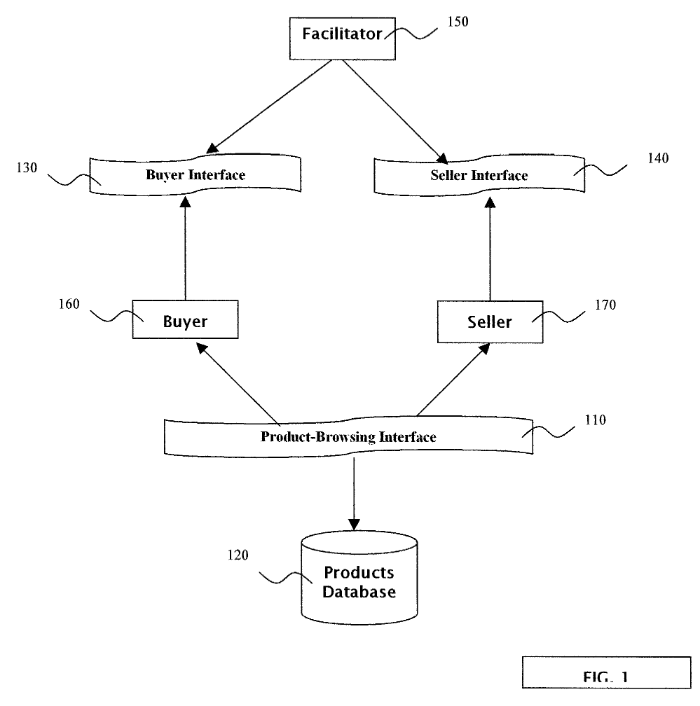

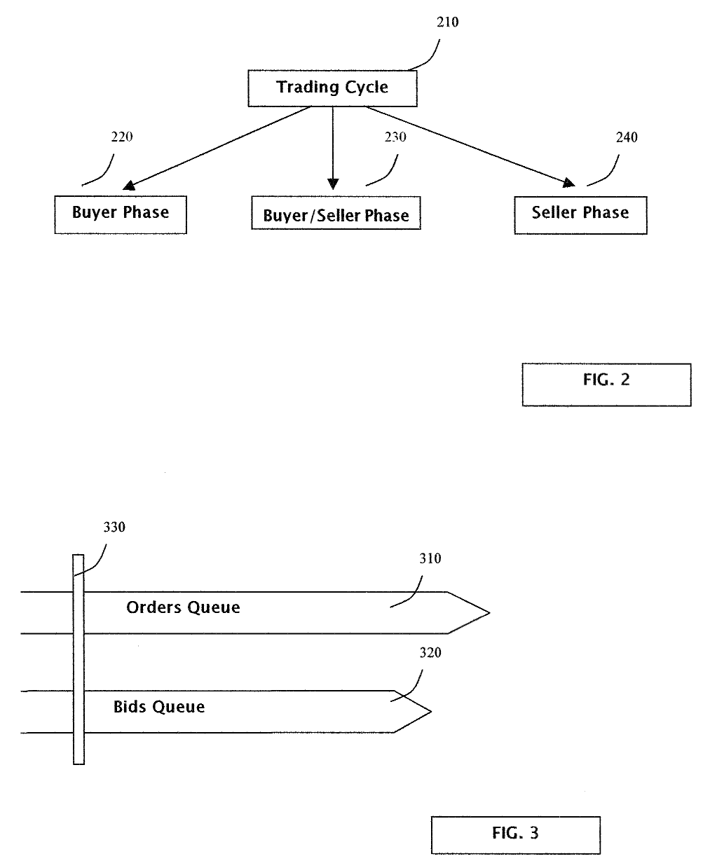

### DETAILED DESCRIPTION OF THE PREFFERED EMBODIMENT

The present invention is a method and apparatus for facilitating the aggregation of buyer power via the Internet or similar networks. It is also a method and apparatus for sellers to sell products in a wholesale manner.

In one preferred embodiment of the invention, buyer oriented on-line reverse auction system consists of a product-browsing interface 110 with products database 120, a buyer interface 130, a seller interface 140 and a facilitator 150 to implement the method introduced in this invention. A server system is configured as Web Server providing access to information such as web pages in HTML format via the HyperText Transport Protocol (http). The server system is also configured to generate cookies and to transfer the cookies to the Client System with Buyer and Seller use. Buyer 160 uses an IBM PC compatible operating the Microsoft Windows operating system to access buyer interface 130. Seller 170 also uses an IBM PC compatible operating the Microsoft Windows operating system to access seller interface 140. Both buyer 160 and seller 170 have access of the product-browsing interface 110.

The biding process has endless trading cycles 210. Each cycle consists three phases: buyer phase 220, buyer seller phase 230 and seller phase 240. Trading cycle is set by the system depending on products. Cheaper or popular products which circulate faster are set with shorter cycle. In one preferred embodiment of the invention, a trading cycle lasts a week. The cycle starts from buyer phase on Friday each week. Buyer phase ends on Tuesday. Buyer seller phase starts on Wednesday and ends the same day. Seller phase starts on Thursday and ends the same day. Another new cycle starts on Friday.

In buyer phase 210, Buyers use the product-browsing interface 110 to research products they are interested in. The system collects information on products, which includes barcode or ISBN number, retail price, specification and price trend chart. All the information is saved in the product database 120. In one preferred embodiment of the invention, product-browsing interface 110 provides barcode or ISBN search so that they uniquely identify the product. It causes no confusion between buyers and sellers. Once a buyer decides on what specific product to buy, he/she uses the buyer interface 130 to submit the buying request that includes request price, units and expiration date. Buyer set request price depending on the retail price that is published by the product-browsing interface. In one preferred embodiment of the invention, request prices are set at levels based on retail price, such as 95%, 90%, 85%, 80% . . . , Expiration date can cross beyond a plurality of trading cycles. Buyer is able to change request at anytime in buyer phase. Request can be added, modified or removed. Buyer also has access to the trading history of this product so that the price set by buyer is reasonable. All requests are sorted based on price and date when request is submitted. Higher request price and earlier submission means better position in the queue. Better position means better chances to get product at lower price. This method encourages buyer to submit reasonable request price earlier in the buyer phase. At the end of buyer phase, each request is granted a position which will not change through the trading cycle.

In buyer seller phase 220, buyers' requests are converted to orders automatically. An order is not allowed to be removed. New orders are still accepted. The position of new order starts from the last position from buyer phase. Buyers can only increase request price and units. Sellers start bidding on the orders at this phase. A bid includes price, units and minimum wholesale units. Price is valid only when enough orders meets the minimum wholesale units. Bidding by seller in this phase attracts more buyers to join the trading cycle and submit new orders. If a seller puts a bid to sell a product at a wholesale price far below retail price, more buyers will be interested to submit orders in this phase.

In seller phase 230, buyers' ordering process is frozen. Only sellers participate in this phase. Bids are ordered based on price and submission date. When seller phase finishes, facilitator matches order queue and bid queue to find the matches between orders and bids. A cut 330 is done in both orders queue and bids queue. Successful orders and bids are sent to both buyers and sellers. Sellers will then work on sale transaction. Unsuccessful orders are converted to requests until next trading cycle starts.

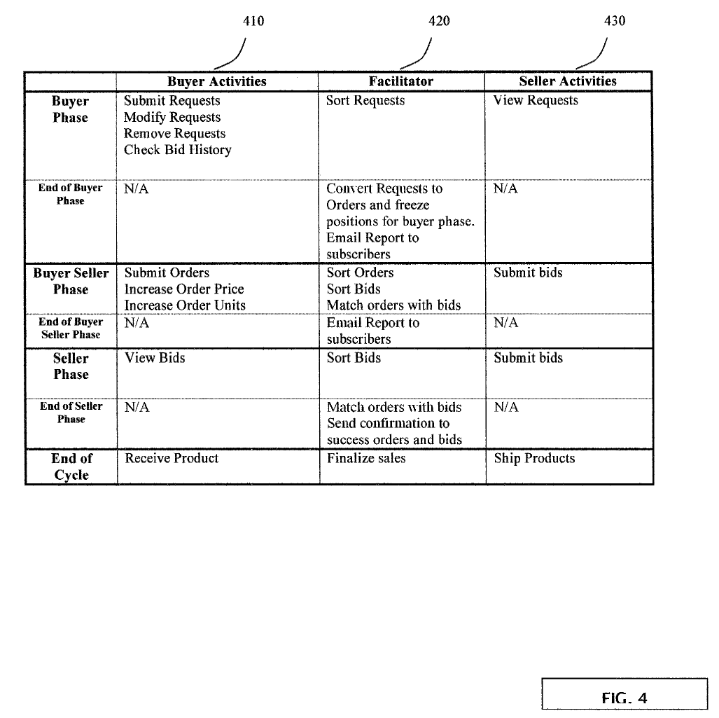

FIG. 4 summarizes the activities of buyer, seller and facilitator in the three different phases.

### EXAMPLE WITH NARRATIVE DESCRIPTION

The buyer oriented on-line reverse auction system is hosting a trading cycle for product Sony S60 Digital Camera at retail price $100. The biding cycle starts on Oct. 29, 2004 and ends on Nov. 4, 2004.

| Phases | Start | End |
|---|---|---|
| Buyer Phase | Oct. 29, 2004(Friday) | Nov. 02, 2004 (Tuesday) |
| Buyer Seller | Nov. 03, 2004(Wednesday) | Nov. 03, 2004(Wednesday) |
| Phase | | |
| Seller Phase | Nov. 04, 2004(Thursday) | Nov. 04, 2004(Thursday) |

The days are selected to benefit all parties in the system. Buyers spend weekend and beginning of the week to research products and make buying decisions. Sellers start to bid in the middle of the week. On Friday, they can ship the product out after the trading cycle ends. Obviously, different trading cycle can be selected depending on product popularity.

In buyer phase, requests are ordered by price threshold descending and date ascending. The system assigns buyer a position number at the time the request is submitted. Position will change in both buyer phase and buyer seller phase. The position will be fixed at the end of buyer seller phase when new orders are not accepted. From the table below, we can see Scott submitted a request on Oct. 30, 2004. He wanted one digital camera at $95. The request expires on Dec. 1, 2004. Mike requested two digital cameras. It could happen that he may just get one after the trading cycle if not enough units are offered at $90.

| Position | Buyer | Price | Units | Submission Date | Expiration Date |
|---|---|---|---|---|---|
| 1 | Scott | 95 | 1 | Nov. 01, 2004 | Dec. 01, 2004 |
| | | | | 11:00 AM(MON) | |
| 2 | Dan | 90 | 1 | Nov. 01, 2004 | Nov. 05, 2004 |
| | | | | 09:00 AM(MON) | |
| 3 | Mike | 90 | 2 | Nov. 02, 2004 | Nov. 05, 2004 |
| | | | | 10:00 AM(TUE) | |
| 4 | Jennifer | 85 | 1 | Nov. 01, 2004 | Dec. 01, 2004 |
| | | | | 07:55 AM(MON) | |
| 5 | Chris | 85 | 1 | Nov. 01, 2004 | Dec. 05, 2004 |
| | | | | 08:00 AM(MON) | |

In buyer seller phase, positions are fixed for buyers who submitted request in buyer seller phase. A bid to sell three cameras at $90 comes in. The system compares the bid with the orders. Apparently, we have three winning buyers already. Scott, Dan and Mike will be the first three in the queue to get the camera. They are guaranteed to have the order filled.

| | Seller | Bid | | | Minimum |
|---|---|---|---|---|---|
| Position | Queue | Price | Units | Date | Wholesale Units |
| 1 | AB | 90 | 3 | Oct. 02, 2004 | 3 |
| | Electronics | | | | |

In buyer seller phase, even if Chris raised price to $95, it would not help him to get the camera. Since the positions are fixed for all the requests submitted in buyer phase. This is to protect buyers who have placed requests earlier. But Chris will get better position than new orders which are submitted in buyer seller phase. Chris really wants to get the camera this week, so he raised the price to $95.

| | Buyer | Request | | | |
|---|---|---|---|---|---|
| Position | Queue | Price | Units | Submit Phase | Submission Date |
| 1 | Scott | 95 | 1 | Buyer | Nov. 01, 2004 |
| | | | | | 11:00 AM(MON) |
| 2 | Dan | 90 | 1 | Buyer | Nov. 01, 2004 |
| | | | | | 09:00 AM(MON) |
| 3 | Mike | 90 | 2 | Buyer | Nov. 02, 2004 |
| | | | | | 10:00 AM(TUE) |
| 4 | Jennifer | 85 | 1 | Buyer | Nov. 01, 2004 |
| | | | | | 07:55 AM(MON) |
| 5 | Chris | 95 | 1 | Buyer | Nov. 01, 2004 |
| | | | | | 08:00 AM(MON) |
| 6 | Kate | 95 | 2 | Buyer/Seller | Nov. 03, 2004 |
| | | | | | 11:30 AM(WED) |
| 7 | Tom | 95 | 1 | Buyer/Seller | Nov. 03, 2004 |
| | | | | | 02:00 PM(WED) |

In seller phase, more bids come in. The bids are sorted based on price and bid date. Here are the bids.

| | Seller | Bid | | | Minimum |
|---|---|---|---|---|---|
| Position | Queue | Price | Units | Date | Wholesale Units |
| 1 | AB | 90 | 3 | Oct. 02, 2004 | 3 |
| | Electronics | | | | |
| 2 | CD | 93 | 6 | Oct. 01, 2004 | 6 |
| | Electronics | | | | |
| 3 | EF | 94 | 5 | Oct. 02, 2004 | 2 |
| | Electronics | | | | |

In this case, AB Electronics will get three orders filled and EF Electronics will get one orders filled. CD Electronics fails the bid because there are not enough orders to satisfy the minimum wholesale unit requirement. Transaction happens only when minimum wholesale units have matching orders.

This is the final match after seller phase:

| | Buyer | | | |
|---|---|---|---|---|
| Position | Queue | Seller Queue | Final Price | Units |
| 1 | Scott | AB Electronics | 90 | 1 |
| 2 | Dan | AB Electronics | 90 | 1 |
| 3 | Mike | AB Electronics | 90 | 1 |
| 3 | Mike | EF Electronics | 94 | 1 |
| 5 | Chris | EF Electronics | 94 | 1 |
| 6 | Kate | EF Electronics | 94 | 2 |

At the beginning of next cycles, the remaining orders will be changed to requests. Buyer queue is reordered based on price and submission date. Buyers can add, modify or remove the request.

| Position | Buyer | Price | Units | Date |
|---|---|---|---|---|
| 1 | Tom | 95 | 1 | Nov. 03, 2004 02:00 PM(WED) |
| 2 | Jennifer | 85 | 1 | Nov. 01, 2004 07:55 AM(MON) |

Benefits of the Invention

Buyers

Everybody has a shopping plan for the next week, month, year or even couple of years. Once user finishes researching and decides what product and brand to buy, buyer starts shopping around for the best price. This is where some buyers save a lot of money while some other buyers just pick up the product from nearest store at most expensive price. With this system, buyers just set the desired price and sit and watch sellers biding with each other to give buyers the lowest price. The more buyers are interested in the same product, the lower price it would be.

Sellers

Sellers have to deal with marketing everyday. How to find buyers is always the most important task for sellers. With this method and apparatus, sellers have access to a large buyer orders' pool. Sellers do not face inventory problems. When bid cycle is over, sellers order products from factories or distributors and distribute to buyers directly. Even factory itself could work as a seller in the system. Depending on the size of order, the factory decides how many products to produce in each trading cycle. Another interesting example is for airlines. Airline companies bid on traveler's plan and decide airplane schedules. Airplane will always be fully occupied. Schedules with not enough interests could be cancelled to save cost. Hotel can also use the system to offer last minutes discount to interested buyers.

What is claimed is:

1. A method for using a computer to facilitate transactions between at least one of a plurality of buyers and at least one of a plurality of sellers, comprising:
setting up substantially continuous trading cycles with predetermined time period for a product;
receiving a request comprising of request price, number of units, expiration date from said buyer during said trading cycle;
receiving a bid comprising of bid price, minimum wholesale units, maximum available units from said seller during said trading cycle;
matching a plurality of orders from said buyers with a plurality of said bids from said sellers with matching criteria;
establishing transactions on matching said orders and said bids at the end of said trading cycle.

2. The method of claim 1 further comprising:
providing means for searching said product by using distinguishable product features whereby said buyer and said seller are ordering and biding on the same or substantially the same said product.

3. The method of claim 1, wherein said trading cycle comprising:
buyer phase wherein providing means for buyer to submit, modify and remove request.

4. The method of claim 1, wherein said trading cycle further comprising buyer seller phase wherein converting requests from said buyer phase into orders, providing means for buyer to increase said request price and number of said units for said order, providing means for said seller to place said bid on said orders.

5. The method of claim 1, wherein said trading cycle further comprising:
seller phase wherein providing means for said seller to place said bid.

6. The method of claim 1, wherein said a plurality of requests are sorted with sorting criteria whereby request with higher said request price, more said units, earlier submission date gets better position in request queue.

7. The method of claim 6, wherein said request sorting criteria comprising:
each said request having a discrete position of a finite number;
said request with higher request price having lower position number;
said request with the same request price but earlier submission date having lower position number.

8. The method of claim 7 wherein said position changes during said buyer phase depending on changes of said requests, whereby submitting, modifying and removing said requests results in resorting of request queue.

9. The method of claim 7 wherein said position set at the end of buyer phase stays the same during said buyer seller phase and said seller phase whereby positions are protected for said requests submitted in said buyer phase.

10. The method of claim 7 wherein said position for new orders during said buyer seller phase changes depending on changes of said new orders whereby submitting, modifying new orders affects the positions of other said new orders submitted during said buyer seller phase.

11. The method of claim 1, wherein said a plurality of bids are sorted with bid sorting criteria whereby bid who with lower said bid price, less minimum wholesale units restriction, earlier submission date gets better position in bid queue.

12. The method of claim 11, wherein said bid sorting criteria comprising:
each said bid having a discrete position of a finite number;
said bid with lower bid price having better position number;
said bid with same bid price but lower minimum wholesale units having better position;
said bid with same said bid price, same said minimum wholesale units but earlier said submission date having better position number.

13. The method of claim 1, wherein said matching criteria comprising:
the first bid in said bid queue is said to have match found when there are enough unmarked requests to satisfy said minimum wholesale units restriction and said bid price;
wherein upon finding a match, bid queue marks success bid and the matching requests and continues with the next bid in said bid queue to find a match and
wherein no match found, bid queue continues with the next bid in said bid queue to find a match.

14. The method in claim 1, wherein said establishing transactions comprising:
closing said marked request with matching said bid in said trading cycle;
sending payment notice to said buyer with said closed requests;
accepting payment from said buyer and forwarding payment with shipping notice to said seller.

15. The method of claim 1, further comprising:
continuously executing a computer program to schedule next said trading cycle after said trading cycle ends.

16. The method of claim 1, further comprising:
continuously executing a computer program to remove successful or expired orders from said order queue and move said order queue to said request queue in said next trading cycle,
whereby said next trading cycle starts with said requests that are not filled and not expired.

17. An apparatus for facilitating transactions between at least one of a plurality of buyers and at least one of a plurality of sellers comprising:
a storage device; and
a processor connected to the storage device,
the storage device storing a program for controlling the processor,
the processor operative with the program to
provide a buyer interface to receive said requests from a plurality of said buyers;
provide a seller interface to accept said bids from a plurality of said sellers;
match a plurality of buyer requests with a plurality of seller bids;
complete transaction by sending payment notices and shipping notices.

18. The apparatus as claimed in claim 17, wherein said buyer interface provides information comprising product specification, review and price trend chart.

19. The apparatus as claimed in claim 17, further comprising a program to continuously setting up said trading cycles.

20. The apparatus as claimed in claim 17, further comprising a program to continuously remove successful or expired orders from said order queue and move said order queue to said request queue in said next trading cycle.
